(19) United States
(12) Patent Application Publication
(10) Pub. No.: US 2008/0102845 A1
(43) Pub. Date: May 1, 2008

(54) System and method for dynamic channel selection in IEEE 802.11 WLANs

(75) Inventor: Yun Zhao, Foster City, CA (US)

Correspondence Address: THELEN REID BROWN RAYSMAN & STEINER LLP, 2225 EAST BAYSHORE ROAD, SUITE 210, PALO ALTO, CA, 94303, US

(73) Assignee: Hitachi, Ltd.

(21) Appl. No.: 11/588,778

(22) Filed: Oct. 26, 2006

(51) Int. Cl. H04Q 7/20

(52) U.S. Cl. 455/450

(57) ABSTRACT

A method comprising receiving a link quality value of a current channel from each of a plurality of wireless stations in a wireless network; using the received link quality values to determine whether link quality of the current channel fails a link quality threshold; and if the link quality fails the link quality threshold, then receiving a signal value of each of at least two other channels from each of the plurality of wireless stations; using the received signal values to determine whether each of the at least two other channels is a candidate channel; using a channel-selection protocol that includes random selection to select one of the candidate channels as a new channel; and setting the new channel as the current channel.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to wireless local area networks, and more particularly provides a system and method for dynamic channel selection in 802.11 WLANS.

### BACKGROUND

Wireless local area networks (WLANs) are becoming more popular. WLANs are now offered by cafes, airports, hotels, businesses, residences, etc. WLANs may be designed to operate using infrastructure mode, ad-hoc mode, or a combination of the two modes.

In infrastructure mode, a single WLAN includes at least one access point (AP) in communication with a plurality of wireless stations (STAs). The combination of a single AP and its STAs is referred to as “a basic service set” or “a BSS.” An AP may include a radio, a wired network interface, and bridging software. A STA may include a computer (mobile or stationary) having a wireless access card. Example STAs may include laptops, desktops, PDAs, cellular telephones, etc. FIG. 1 illustrates an example BSS network 100 including two BSSs 105a and 105b (each generally referred to as a BSS 105), each coupled to a computer network 110 such as the wide area network commonly referred to as the Internet. The BSS 105a includes an AP 115a and three (3) STAs 120a. The BSS 105b includes an AP 115b and two (2) STAs 120b. Wireless communication by the STAs 120a of BSS 105a goes through the AP 115a. Wireless communication by the stations 120b of BSS 105b goes through the AP 115b. Since most corporate WLANs require access to a wired LAN for services (e.g., file servers, network printers, Internet links, etc.), corporate WLANs typically operate using infrastructure mode.

In ad-hoc mode, a group of STAs operate in a manner analogous to a peer-to-peer network, in which there is no AP and no single STA is required to function as the AP. The combination of STAs in the ad-hoc network is commonly referred to as “an independent basic service set,” “an independent BSS” or “an IBSS.” FIG. 2 illustrates an IBSS 200 having four (4) STAs 205. As shown, each STA 205 is capable of communicating directly or indirectly with the other STAs 205 of the ad-hoc network 200. Ad-hoc networks 200 are useful when quick and easy setup of a WLAN is desired, where connection to a wired network is not needed (e.g., where services may not be offered, such as in a hotel room, convention center, airport, etc.), and/or where access to a wired network is barred (e.g., for consultants at a client site).

It should be appreciated that a WLAN operating using infrastructure mode, ad-hoc mode or a combination of the two can be referred to as a BSS.

When two or more BSSs (whether using infrastructure and/or ad-hoc mode) are located proximate to each other and are operating over the same channel, link quality may deteriorate, e.g., due to contention among the overlapping BSSs and/or signal interference. Accordingly, it becomes difficult to guarantee quality of service (QoS), e.g., for real-time multimedia applications, over WLANs. For example, in FIG. 1, if the BSS 105a were located proximate to BSS 105b, then the BSSs may interfere with each other. Similarly, if the IBSS 200 (FIG. 2) were located next to the BSS 105a (FIG. 1), interference may occur.

Systems and methods are needed to improve link quality caused by overlapping BSSs. Example prior art references include:

| U.S. Patent/Publ. No. | Inventor | Issue/Publ. Date |
|---|---|---|
| U.S. Pat. No. 6,333,937 B1 | Ryan | Dec. 25, 2001 |
| U.S. Pat. No. 6,985,461 B2 | Singh | Jan. 10, 2006 |
| U.S. Pat. No. 6,738,599 B2 | Black, et al. | May 18, 2004 |
| US 2003/0181211 A1 | Razavilar, et al. | Sep. 25, 2003 |
| US 2004/0264413 A1 | Kaidar, et al. | Dec. 30, 2004 |
| US 2005/0003827 A1 | Whelan | Jan. 06, 2005 |
| US 2005/0122999 A1 | Scherzer, et al. | Jun. 09, 2005 |
| US 2006/0029023 A1 | Cervello, et al. | Feb. 09, 2006 |

### SUMMARY

Per one embodiment, the present invention provides a method comprising receiving a link quality value of a current channel from each of a plurality of wireless stations in a wireless network; using the received link quality values to determine whether link quality of the current channel fails a link quality threshold; and if the link quality fails the link quality threshold, then receiving a signal value of each of at least two other channels from each of the plurality of wireless stations; using the received signal values to determine whether each of the at least two other channels is a candidate channel; using a channel-selection protocol that includes random selection to select one of the candidate channels as a new channel; and setting the new channel as the current channel.

The method may further comprise determining by one of the wireless stations in the wireless network that the link quality of the current channel from the perspective of the one of the wireless stations is below the link quality threshold; sending a message by the one of the wireless stations to an access point; and initiating by the access point the step of receiving in response to the message. The method may further comprise determining that a period of time has expired; and initiating the step of receiving in response to the step of determining. The step of using the received signal values to determine whether each of the at least two other channels is a candidate channel may include determining whether each of the received signal values fails a signal value threshold; and excluding an other channel that fails the signal value threshold. The step of determining whether each of the received signal values fails the signal value threshold may include using a weighted average protocol that weights the signal values. The channel-selection protocol may include determining whether each candidate channel is an overlapping channel or a nonoverlapping channel; grouping the candidate channels are nonoverlapping in a first priority group; and grouping the candidate channels that are overlapping channels in a second priority group. The channel-selection protocol may include selecting at random one of the candidate channels from the first priority group as the new channel, if the first priority group includes at least two candidate channels. The channel-selection protocol may include determining that the first priority group includes no candidate channels; ranking the candidate channels of the second priority group in order of signal quality; selecting a predetermined number of candidate channels from the candidate channels of the second priority group based on the ranking; and selecting at random at least one of the candidate channels of the predetermined number of candidate channels as the new channel. The method may be performed by an access point in a basic service set of the wireless network or by a controller station in an ad-hoc network of wireless stations.

Per another embodiment, the present invention provides a system comprising a current channel assessment module for receiving a link quality value of a current channel from each of a plurality of wireless stations in a wireless network, and for using the received link quality values to determine whether link quality of the current channel fails a link quality threshold; a candidate channel assessment module for receiving a signal value of each of at least two other channels from each of the plurality of wireless stations, and for using the received signal values to determine whether each of the at least two other channels is a candidate channel; a new channel selection module for using a channel-selection protocol that includes random selection to select one of the candidate channels as a new channel; and a new channel setting module for setting the new channel as the current channel.

The system may further comprise means for determining by one of the wireless stations in the wireless network that the link quality of the current channel from the perspective of the one of the wireless stations is below the link quality threshold, and for sending a message to an access point; wherein the current channel assessment module initiates receiving link quality values in response to the message. The current channel assessment module is operative to determine that a period of time has expired and to initiate the receiving of link quality values in response to the expiration of the period of time. The candidate channel assessment module may be operative to determine whether each of the received signal values fails a signal value threshold, and to exclude an other channel that fails the signal value threshold. The candidate channel assessment module may use a weighted average protocol that weights the signal values. The channel-selection protocol may include determining whether each candidate channel is an overlapping channel or a nonoverlapping channel; grouping the candidate channels that are nonoverlapping in a first priority group; and grouping the candidate channels that are overlapping channels in a second priority group. The channel-selection protocol may include selecting at random one of the candidate channels from the first priority group as the new channel, if the first priority group includes at least two candidate channels. The channel-selection protocol may include determining that the first priority group includes no candidate channels; ranking the candidate channels of the second priority group in order of signal quality; selecting a predetermined number of candidate channels from the candidate channels of the second priority group based on the ranking; and selecting at random at least one of the candidate channels of the predetermined number of candidate channels as the new channel. The system may operate as an access point in a basic service set of a wireless network or operates as a controller station in an ad-hoc network of wireless stations.

Per yet another embodiment, the present invention provides a wireless station in a wireless network, comprising means for determining a link quality value of a current channel; means for determining a signal value of each of at least two other channels; and means for determining a new channel designation, the new channel designation being generated by a channel-selection protocol that includes random selection, and for setting the new channel as the current channel.

The wireless network may include an ad-hoc network; the wireless station may operate as a controller, and the wireless station may include a current channel assessment module for receiving a link quality value of a current channel from each of a plurality of wireless stations in the wireless network, and for using the received link quality values to determine whether link quality of the current channel fails a link quality threshold; a candidate channel assessment module for receiving a signal value of each of at least two other channels from each of the plurality of wireless stations, and for using the received signal values to determine whether each of the at least two other channels is a candidate channel; and a new channel selection module for using a channel-selection protocol that includes random selection to select one of the candidate channels as a new channel.

### BRIEF DESCRIPTION OF THE DRAWINGS

FIG. 1 is block diagram of a basic service set (BSS) network, in accordance with the prior art.

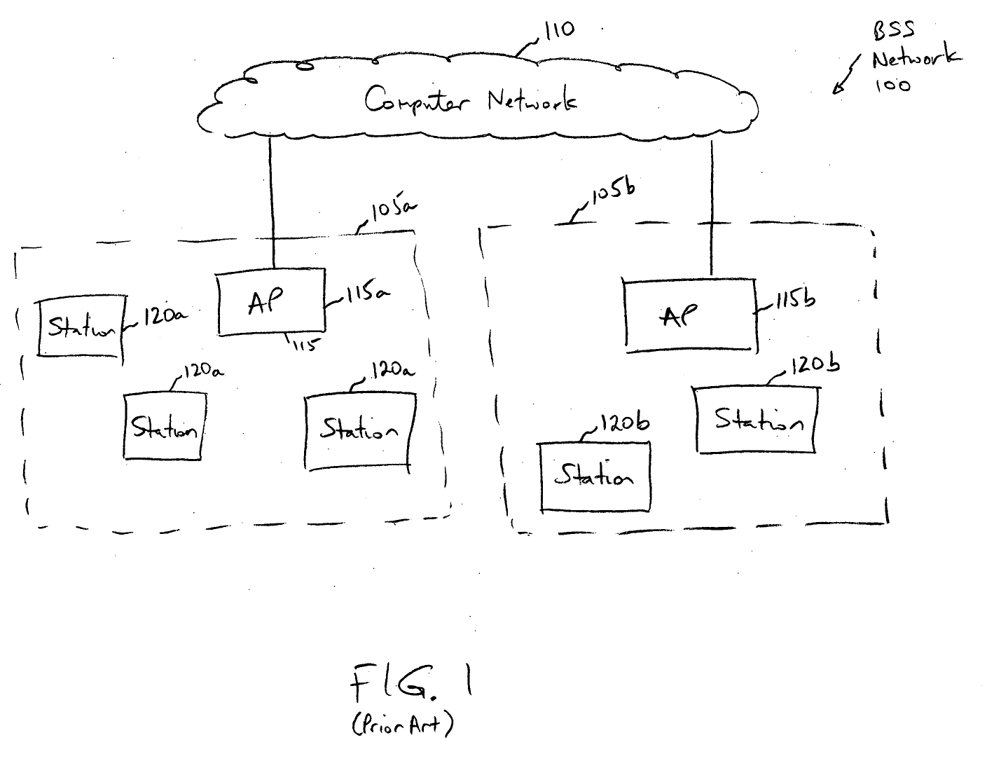

FIG. 2 is a block diagram of an independent basic service set (IBSS), in accordance with the prior art.

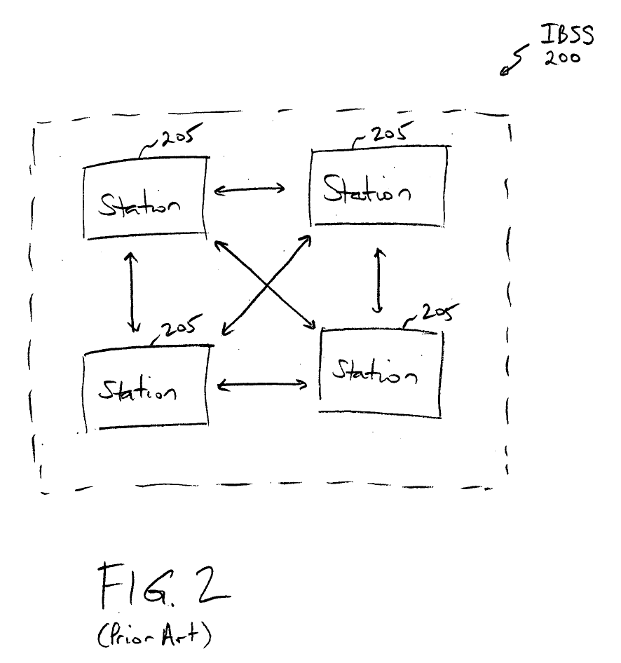

FIG. 3 is a block diagram of a BSS network using infrastructure mode and channel control, in accordance with an embodiment of the present invention.

FIG. 4 is a block diagram of a channel control module of FIG. 3, in accordance with an embodiment of the present invention.

FIG. 5 is a block diagram of a channel agent module of FIG. 3, in accordance with an embodiment of the present invention.

FIG. 6 is a block diagram of a prior art MAC frame.

FIG. 7 is a block diagram of a prior art frame control field of FIG. 6.

FIG. 8 is a block diagram of an IBSS with channel control, in accordance with an embodiment of the present invention.

FIG. 9 is a block diagram of an ad-hoc channel control module, in accordance with an embodiment of the present invention.

FIG. 10 is a flowchart of a method of controlling channel selection, in accordance with an embodiment of the present invention.

FIG. 11 illustrates a first example scenario, in accordance with an embodiment of the present invention.

FIG. 12 illustrates a second example scenario, in accordance with an embodiment of the present invention.

### DETAILED DESCRIPTION

The following description is provided to enable any person skilled in the art to make and use the invention, and is provided in the context of a particular application and its requirements. Various modifications to the embodiments are possible to those skilled in the art, and the generic principles defined herein may be applied to these and other embodiments and applications without departing from the spirit and scope of the invention. Thus, the present invention is not intended to be limited to the embodiments shown, but is to be accorded the widest scope consistent with the principles, features and teachings disclosed herein.

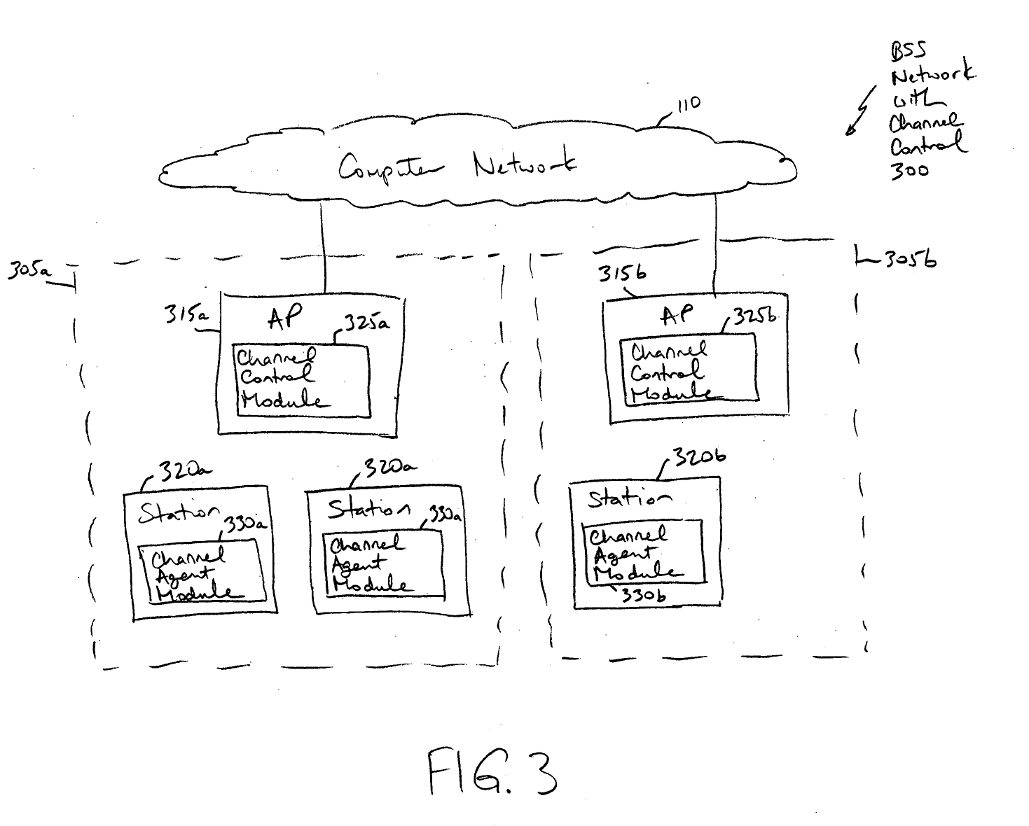

FIG. 3 is a block diagram of a BSS network 300 using infrastructure mode and channel control, in accordance with an embodiment of the present invention. The BSS network 300 includes a first BSS 305a and a second BSS 305b (each generally referred to as a BSS 305), each coupled to the computer network 110. The first BSS 305a includes an AP 315a and two STAs 320a. The second BSS 305b includes an AP 315b and one STA 320b. The AP 315a includes a channel control module 325a. The AP 315b includes a channel control module 325b, which may be the same as the channel control module 325a. Each STA 320a includes a channel agent module 330. Each STA 320b includes a channel agent module 330b, which may be the same as the channel agent module 330a. Each of the AP 315a and the AP 315b may be generally referred to as an AP 315. Each of the STAs 320a and STA 320b may be generally referred to as a STA 320. Each of the channel control module 325a and the channel control module 325b may generally be referred to as a channel control module 325. Each of the channel agent module 330a and the channel agent module 330b may generally be referred to as a channel agent module 330.

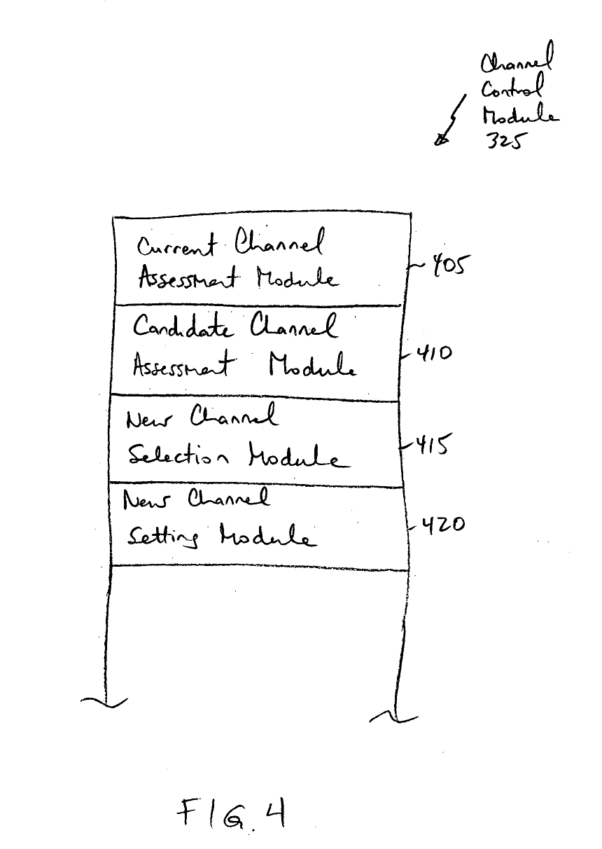

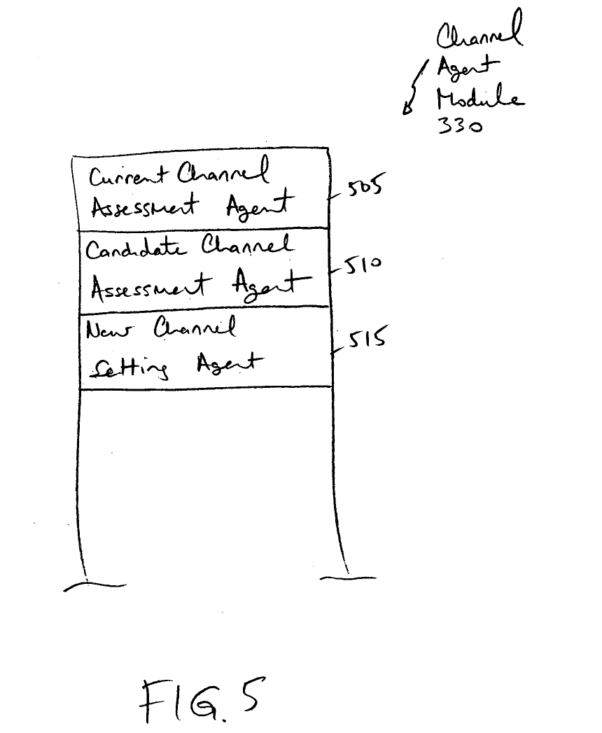

In one embodiment, each channel control module 325 includes hardware, software and/or firmware to enable current channel quality assessment, candidate channel quality assessment, new channel selection, and new channel configuration. Additional details of the channel control module 325 will be described below with reference to FIG. 4. Each channel agent module 330 includes hardware, software and/or firmware to enable current channel quality assessment, candidate channel quality assessment, and new channel configuration. Each channel agent module 330 will be described below with reference to FIG. 5.

Generally, the channel control module 325 and the channel agent modules 330 of the STAs 320 of a BSS 305 cooperate to evaluate current channel link quality, to determine when a channel change is needed, to evaluate the quality of other channels, to determine candidate channels (e.g., those better than the current channel), to select a new channel from the candidate channels, and to enable a channel change.

It will be appreciated that the channel control module 325 and channel agent modules 330 may initially configure the BSS 305 to communicate over a default channel, over a randomly selected channel from the available channels, etc. The channel control module 325 and channel agent modules 330 may select a new channel from a predetermined priority set of candidate channels when link quality is insufficient, and may select from a lower priority set of candidate channels when link quality is insufficient and when none of the priority set of candidate channels is available. The channel control module 325 and channel agent modules 330 may reassess current channel link quality on a periodic basis. In one embodiment, the channel control module 325 may initiate current channel quality assessment. In another embodiment, each channel agent module 330 may independently assess current channel link quality (e.g., substantially continuously or on a periodic basis), and may inform the channel control module 325 when current channel link quality is below a threshold. Then, the channel control module 325 may initiate candidate channel assessment and new channel selection.

FIG. 4 is a block diagram of a channel control module 325, in accordance with an embodiment of the present invention. The channel control module 325 includes a current channel assessment module 405, a candidate channel assessment module 410, a new channel selection module 415 and a new channel setting module 420.

The current channel assessment module 405 includes hardware, software and/or firmware to initiate/schedule link quality assessment of a current channel, e.g., upon setup, on a periodic basis, on an event-initiated basis, upon request by a STA 120, upon user request, etc. In one embodiment, the current channel assessment module 405 communicates with the channel agent module 330 of each STA 320, e.g., to initiate and define a time period T over which the link assessment module 410 and the channel agent module 330 will measure link quality. In another embodiment, the time period T may be predefined. The time period T (length, start time, etc.) of the channel control module 410 and of the channel agent module 330 need not be the same.

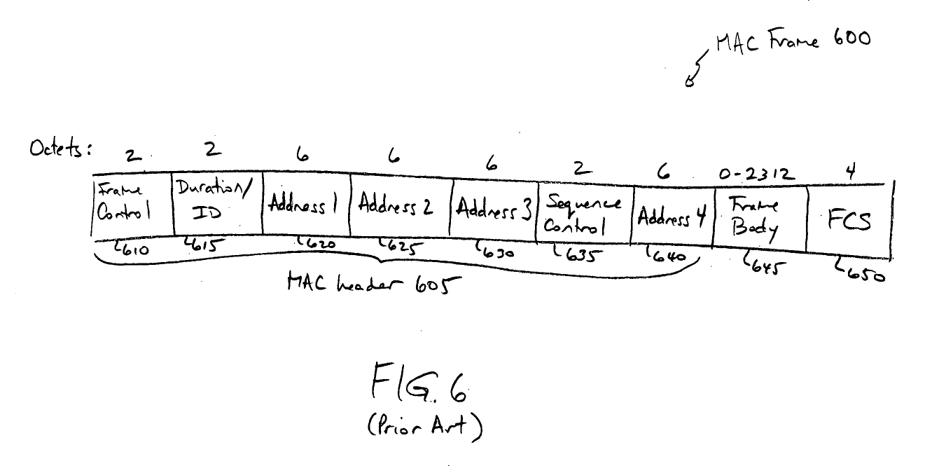

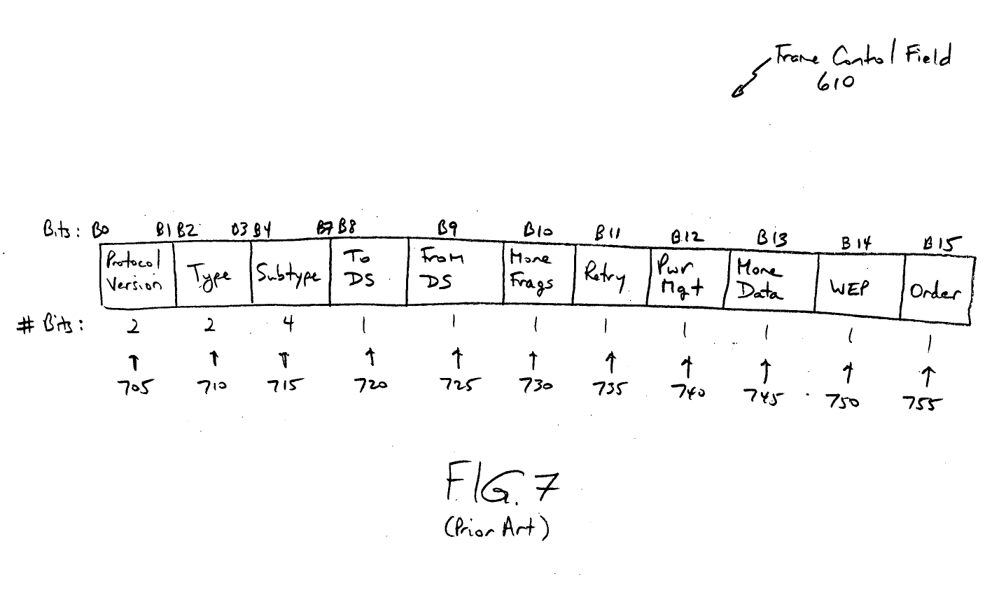

In one embodiment, the current channel assessment module 405 also includes hardware, software and/or firmware to evaluate link quality of the current channel as noted by the AP 315. The current channel assessment module 405 determines link quality by measuring the received signal strength indication (RSSI), noise, the signal-to-noise ratio (SNR), and/or the like. In one embodiment, the current channel assessment module 405 measures MAC layer link quality by inspecting the retry field in the frame header and counting the number of retries in a given time period T. FIG. 6 is a block diagram of a prior art MAC frame 600. The MAC frame 600 includes a MAC header 605 having a frame control field 610 of two octets, a duration/ID field 615 of two octets, a first address field 620 of 6 octets, a second address field 625 of 6 octets, a third address field 630 of 6 octets, a sequence control field 635 of 2 octets, and a fourth address field 640 of 6 octets. The MAC frame 600 also includes a frame body field 645 of 0-2312 octets and a frame check sequence (FCS) field 650 of 4 octets. FIG. 7 is a block diagram illustrating details of the frame control field 610 in accordance with the prior art. The frame control field 610 includes a protocol version field 705 of 2 bits (B0-B1), a type field 710 of 2 bits (B2-B3), a subtype field 715 of 4 bits (B4-B7), a To distribution system (DS) field 720 of 1 bit (B8), a From DS field 725 of 1 bit (B9), a more fragments field 730 of 1 bit (B10), a retry field 735 of 1 bit (B11), a power management field 740 of 1 bit (B12), a more data field 745 of 1 bit (B13), a wireless encryption protocol (WEP) field 750 of 1 bit (B14), and an order field 755 of 1 bit (B15). The current channel assessment module 405 counts the number of frames in the time period T in which the retry field 735 (B11) of a frame sent or received by the AP 315 is set to 1 (identifying a retry).

In one embodiment, the current channel assessment module 405 receives link quality values (possibly measured in the same manner as the AP 315) from each STA 320. In one embodiment, the current channel assessment module 405 averages the link quality values received from the STAs 315 and the link quality value measured by the current channel assessment module 405 itself, and compares the average link quality values against a predefined threshold to determine whether a new channel may be needed. If the average link quality values is greater than the predefined threshold (e.g., when measuring link quality values such as noise, retry count, etc.) and/or is less than a predefined threshold (e.g., when measuring link quality values such as RSSI, SNR, etc.), then the current channel assessment module 405 requests candidate channel signal quality assessment within the BSS 305b to determine whether a better channel exists. In another embodiment, the current channel assessment module 405 compares a weighted average of the link quality values for comparison against the predetermined threshold. The weighted average may use a higher weight when the current link value is weak (e.g., lower than a weak threshold), may use a medium weight when the current link value is mediocre (e.g., higher than the weak threshold, but lower than a mediocre threshold), and may use a lower weight when the current link value is satisfactory (e.g., higher than the mediocre threshold). Other weighting options, e.g., sliding scale, any number of segments, etc., are also possible.

In another embodiment, the current channel assessment module 405 of the AP 115 itself does not evaluate link quality of the current channel, and relies only on the link quality values measured by the channel agent module 330 of each STA 320.

The candidate channel assessment module 410 includes hardware, software and/or firmware to evaluate other channels as channel candidates and to communicate with the channel agent module 330 of each STA 320. In one embodiment, the candidate channel assessment module 410 of the AP 315 measures a signal value, e.g., RSSI, noise/traffic on a channel, SNR, and/or the like, of each of the other channels. Then, the candidate channel assessment module 410 communicates with the channel agent module 330 of each STA 320 to receive the signal values for the other channels as measured by each STA 320. The candidate channel assessment module 410 uses the signal values to determine whether to add each other channel to the set of channel candidates.

In one embodiment, to determine whether to add an other channel to the set, the candidate channel assessment module 410 compares the signal values measured/received on an individual basis and/or an average signal value of some or all other channels against a predetermined threshold. For example, the candidate channel assessment module 410 may count the STAs 320 having measured a signal value greater or less than the predetermined threshold. In one embodiment, the predetermined threshold may be determined from the signal values measured/received and/or an average signal value of the current channel. In another embodiment, to determine whether to add an other channel to the list, the candidate channel assessment module 410 determines the top three (3) or other number of the other channels. In yet another embodiment, the candidate channel assessment module 410 compares a weighted average of the signal values for comparison against a predetermined threshold. The weighted average may use a higher weight when a STA 115 finds the signal value weak (e.g., lower than a weak threshold), may use a medium weight when a STA 115 finds the signal value mediocre (e.g., higher than the weak threshold, but lower than a mediocre threshold), and may use a lower weight when a STA 115 finds the signal value satisfactory (e.g., higher than the mediocre threshold). Other weighting options, e.g., sliding scale, any number of segments, etc., are also possible.

In still another embodiment, the candidate channel assessment module 410 may exclude other channels in use by one or more other BSSs 305 with priority use (e.g., an earlier date of first use) and/or may prioritize those other channels not in use. For example, the channel control module 325 of the AP 315 may send a periodic “heartbeat” signal, possibly with a date/time stamp indicating when the AP 315 began using its channel. That way, other BSSs 305 in range will know to exclude the channel from the set and/or to prioritize the other channels. It will be appreciated that prioritization may not satisfy all scenarios. For example, not every BSS 305 may be capable of channel control. Accordingly, in certain embodiments, a preexisting BSS 305 with channel control may have to switch channels when a new BSS 105 without channel control uses a channel which begins to interfere with it. In yet another embodiment, the candidate channel assessment module 410 excludes only those other channels in use by an other BSS 305 with priority only if the interference is greater than an interference threshold (or, e.g., prioritizes the other channels other than those in use with interference greater than the certain threshold). An other channel may be deemed in use if the AP 115 determines that its interference level is greater than a threshold, as measured by the AP 115, as measured by a STA 120, as averaged by the AP 115 and the STAs 120, as averaged by a subset of the AP 115 and the STAs 120, etc.

In one embodiment, the candidate channel assessment module 410 evaluates other channels from a predetermined channel list that possibly includes non-overlapping and overlapping channels. In 802.11b and 802.11g, there are three (3) standard non-overlapping channels, namely, channel 1 (2.412 GHz), channel 6 (2.437 GHz) and channel 11 (2.462 GHz) in the 2.4 GHz bandwidth in North America. Overlapping channels may include channels between these channels such as channels 2, 3, 4, 5, 7, 8, 9, 10, 11, etc. (The FCC current does not allow private use of channels above channel 11.) The candidate channel assessment module 410 may prioritize standard non-overlapping channels over non-standard channels and over overlapping channels.

In one embodiment, the candidate channel assessment module 410 sends out a request for channel measurement to the STAs 320 associated with the BSS 305. In the request, the candidate channel assessment module 410 specifies (1) which channel to measure; (2) the duration of measurement; (3) the start time of measurement. In another embodiment, the STAs 320 initiate channel measurement on a periodic basis.

The new channel selection module 415 includes hardware, software and/or firmware to select a new channel from the set of candidate channels by using predefined decision criteria. In one embodiment, the new channel selection module 415 selects the new channel as the candidate channel having the best signal value response, e.g., the highest RSSI, the lowest noise, the greatest SNR, and/or the like. In another embodiment, the new channel selection module 415 randomly selects one of the candidate channels in the set, possibly using uniform or non-uniform distribution. In yet another embodiment, the new channel selection module 415 selects one of the candidate channels in an ordered fashion.

In still another embodiment, the new channel selection module 415 ranks the candidate channels into prioritized groups, and uses group-dedicated algorithms to select the new channel. For example, the new channel selection module 415 may group nonoverlapping channels not in use (with noise less than a noise threshold, etc.) by another BSS 105 into a first priority group, overlapping channels not in use by another BSS 105 into a second priority group, and other channels in use (with noise greater than a threshold, etc.) in a third priority group. The new channel selection module 415 may select the new channel at random from the first priority group. If there are no candidate channels in the first priority group, then the new channel selection module 415 may select the new channel from the second priority group, e.g., by ranking the candidate channels of the second priority group in order of best signal values, selecting the top X (e.g., 3) candidate channels, and randomly selecting one of the top X candidate channels as the new channel. If there are no candidate channels in either the first or second priority group, the new channel selection module 415 may decide not to change channels or to select the new channel from the third priority group, e.g., by ranking the channels of the third priority group, selecting the top Y (e.g., 3) channels, and randomly selecting one of the top Y candidate channels as the new channel. The new channel selection module 415 may not change channels if no channel in the third priority group has better signal values than the current channel. Alternatively, the new channel selection module 415 may be configured to select the channel with the best signal values from a priority group.

Exclusion of other channels in use and/or prioritization of the channels not in use may be implemented by the new channel selection module 415, instead of by the candidate channel assessment module 410.

The new channel setting module 420 includes hardware, software and/or firmware to set the channel of the BSS 105 to the new channel and to inform the STAs 320 to set their channel to the new channel.

FIG. 5 is a block diagram of a channel agent module 330, in accordance with an embodiment of the present invention. The channel agent module 330 includes a current channel assessment agent 505, a candidate channel assessment agent 510, and a new channel setting agent 515.

The current channel assessment agent 505 operates in a similar manner to the current channel assessment module 405 of the channel control module 325. The current channel assessment agent 505 includes hardware, software and/or firmware to communicate with the current channel assessment module 405 of the channel control module 325, e.g., to obtain the time period T over which the current channel assessment module 505 measures current channel link quality. As stated above, in one embodiment, the time period T may be predefined. In another embodiment, the current channel assessment agent 505 may be configured to initiate current channel link quality assessment on a periodic or substantially continuous basis. Upon detection of poor link quality (e.g., link quality lower than a threshold), the current channel assessment agent 505 may inform the current channel assessment module 405 of the AP 115 of the poor link quality.

Like the current channel assessment module 405, the current channel assessment agent 505 of each STA 320 also includes hardware, software and/or firmware to measure link quality values of the current channel (as noted by the associated STA 320). In one embodiment, the current channel assessment agent 505 measures link quality by measuring RSSI, noise, SNR, and/or the like. In one embodiment, the current channel assessment agent 505 inspects the retry field in the frame header and counts the number of retries to and from the corresponding STA 320. The current channel assessment agent 505 of each STA 320 reports the link quality values to the channel control module 325 of the AP 315, which uses the link quality values to determine whether to seek a better channel.

The candidate channel assessment agent 510 is similar to the candidate channel assessment module 410 of the channel control module 325. The candidate channel assessment agent 510 includes hardware, software and/or firmware to evaluate other channels as channel candidates. In one embodiment, the candidate channel assessment module 510 measures a signal value, e.g., RSSI, noise/traffic on a channel, SNR and/or the like, of each other channel. The set of other channels to evaluate may be predefined or received dynamically from the candidate channel measure module 410. The candidate channel assessment module 510 sends the signal values measured to the candidate channel assessment module 410, which uses the signal values to determine channel candidates.

In one embodiment, the candidate channel assessment agent 510 performs channel measurement by sending out a management primitive MLME-SCAN.request. The primitive MLME-SCAN.confirm returns the scan results back to the STAs 320. The STAs 320 measure the RSSI to determine channel condition. 802.11 PHYs define the RSSI parameter as part of the RXVECTOR parameter list in the PHY-RXSTART. indicate service primitive. The RSSI is a parameter that has a value of 0 through RSSI Max. In one embodiment, this parameter is a measure by the PHY sublayer of the energy observed at the antenna used to receive the current physical layer convergence protocol data unit (PPDU). RSSI shall be measured between the beginning of the start frame delimiter (SFD) and the end of the physical layer convergence protocol (PLCP) header error check (HEC).

The new channel setting agent 515 is similar to the new channel setting module 420. The new channel setting agent 420 of each STA 320 includes hardware, software and/or firmware to receive the identification of the new channel from the new channel setting module 420, and to set the current channel to the new channel.

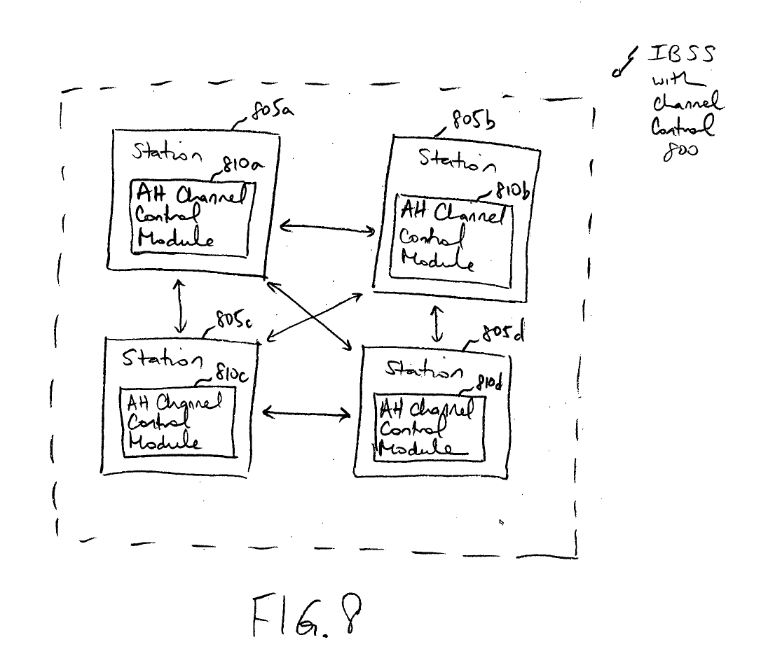

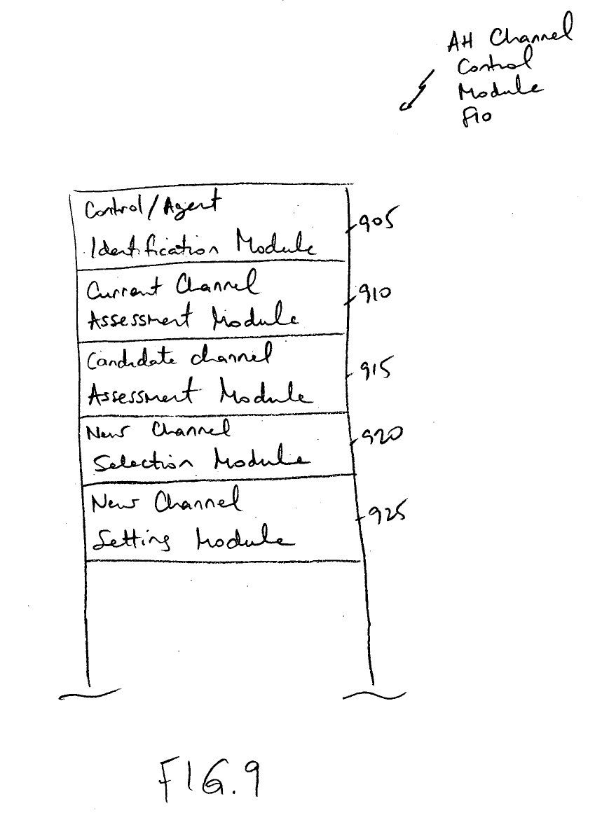

FIG. 8 is a block diagram of an IBSS 800 with channel control, in accordance with an embodiment of the present invention. The IBSS 800 includes four (4) ad-hoc STAs 805a-805d, each having an ad-hoc channel control module 810a-810d, respectively. Each STA 805a-805d may be generally referred to as STA 805. Each ad-hoc channel control module 810a-810d may be generally referred to as ad-hoc channel control module 810. Channel control in the IBSS 800 operates in a similar manner to channel control in the BSS network 300, except that a controller (similar to the AP 315) needs to be identified. Details of the ad-hoc channel control module 810 is described in greater detail with reference to FIG. 9.

FIG. 9 is a block diagram of an ad-hoc channel control module 810, in accordance with an embodiment of the present invention. The ad-hoc channel control module 810 includes a control/agent identification module 905, a current channel assessment module 910, a candidate channel assessment module 915, a new channel selection module 920, and a new channel setting module 925.

The control/agent identification module 905 includes hardware, software and/or firmware to enable the STAs 805 to determine which STA 805 shall act as the controller (e.g., similar to the AP 315 of the BSS network 300). In this embodiment, because each STA 805 includes an identical ad-hoc control module 810, each STA 805 is capable of acting as the controller. The controller may be selected arbitrarily, randomly, manually, etc. The controller may be selected as the STA 320 with the fastest CPU, the largest bandwidth, the least interference, etc. The controller may be selected based on serial numbers of the ad-hoc controller module 810. A STA 320 that first determines the current channel fails a threshold test may become the controller. Other possibilities also exist.

The current channel assessment module 910 includes hardware, software and/or firmware to operate like the current channel assessment module 405 if the STA 805 is designated as the controller and like the current channel assessment agent 505 if the STA 805 is not designated as the controller.

The candidate channel assessment module 915 includes hardware, software and/or firmware to operate like the candidate channel assessment module 410 if the STA 805 is designated as the controller and like the candidate channel assessment agent 510 if the STA 805 is not designated as the controller.

The new channel selection module 920 includes hardware, software and/or firmware to operate like the new channel selection module 415 if the STA 805 is designated as the controller and to be dormant if the STA 805 is not designated as the controller.

The new channel setting module 925 includes hardware, software and/or firmware to operate like the new channel setting module 420 if the STA 805 is designated as the controller as like the new channel setting agent 515 if the STA 805 is not designated as the controller.

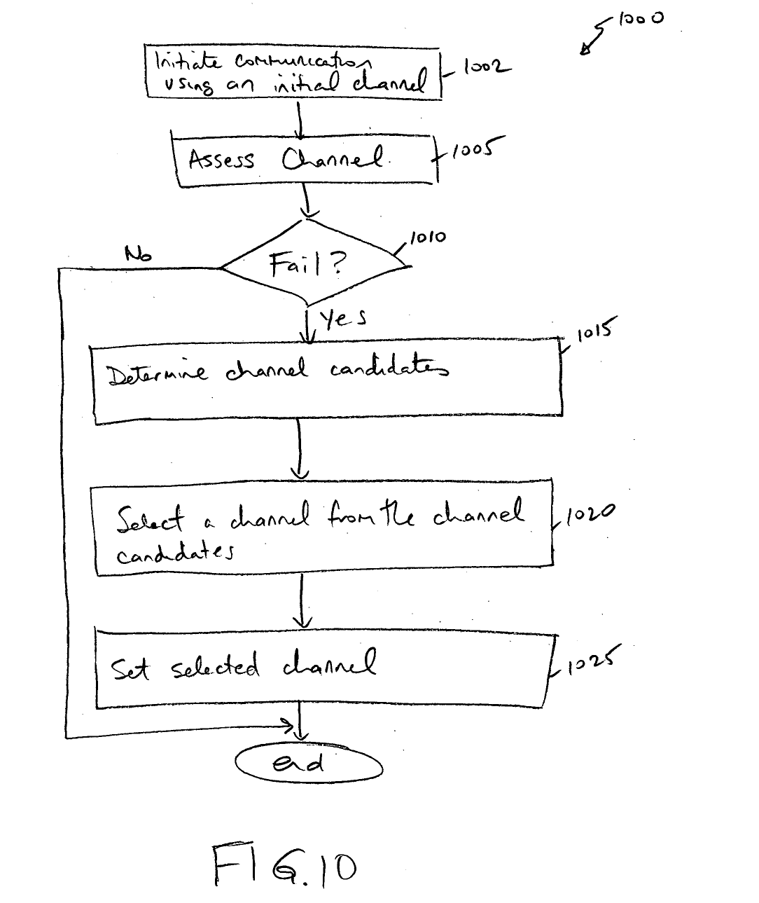

FIG. 10 is a flowchart of a method 1000 of controlling channel selection, in accordance with an embodiment of the present invention. The method 1000 begins with the AP 315 and/or STAs 320/805 in step 1002 initiating communication using an initial channel. In one embodiment, the initial channel may be a default channel. In another embodiment, the initial channel may be randomly selected from available channels.

The current channel assessment module 405/505/910 in step 1005 assesses link quality of the current channel. In one embodiment, link quality is measured by monitoring the retry field and counting the number of retries during a time period T. In another embodiment, RSSI, noise, SNR and/or the like is measured. The current channel assessment module 405/910 in step 1010 determines whether the current channel fails, e.g., has link quality above or below a threshold.

The candidate channel assessment module/agent 410/510/915 in step 1015 measures signal values of other channels. The other channels may include standard nonoverlapping, nonstandard channels and/or overlapping channels. In one embodiment, channels currently being used by other BSSs 305/800 are excluded from the other channels. Using measured signal values of the other channels, the candidate channel assessment module 410/915 determines candidate channels. In one embodiment, candidate channels are determined by comparing the measured signal values and/or an average of some or all the measured signal values of the other available channels against a threshold. In another embodiment, candidate channels are determined by comparing the measured signal values or an average of the measured signal values of the other channels against the signal values or the average of the signal value of the current channel. In yet another embodiment, the signal values may be weighted. The threshold may be based on the signal values of the current channel and/or on other criteria.

The new channel selection module 415/920 in step 1020 selects a new channel from the candidate channels. In one embodiment, the new channel is selected randomly (e.g., using a uniform or non-uniform distribution). In another embodiment, the channel is selected as the channel having the greatest RSSI, least noise, greatest SNR, etc. In another embodiment, the new channel selection module 415/920 groups candidate channels into priority groups (e.g., not in use and nonoverlapping, not in use and overlapping, in use and nonoverlapping, in use and overlapping, etc.), and selects the new channel from the priority groups based on an algorithm corresponding to the priority group. For example, the new channel selection module 415/910 may select a new channel at random from the first priority group, a new channel at random from a priority subset of the second priority group, a new channel at random from a priority subset of the third priority group, etc.

The new channel setting module 420/515/925 sets the current channel to the new channel. Method 1000 then ends.

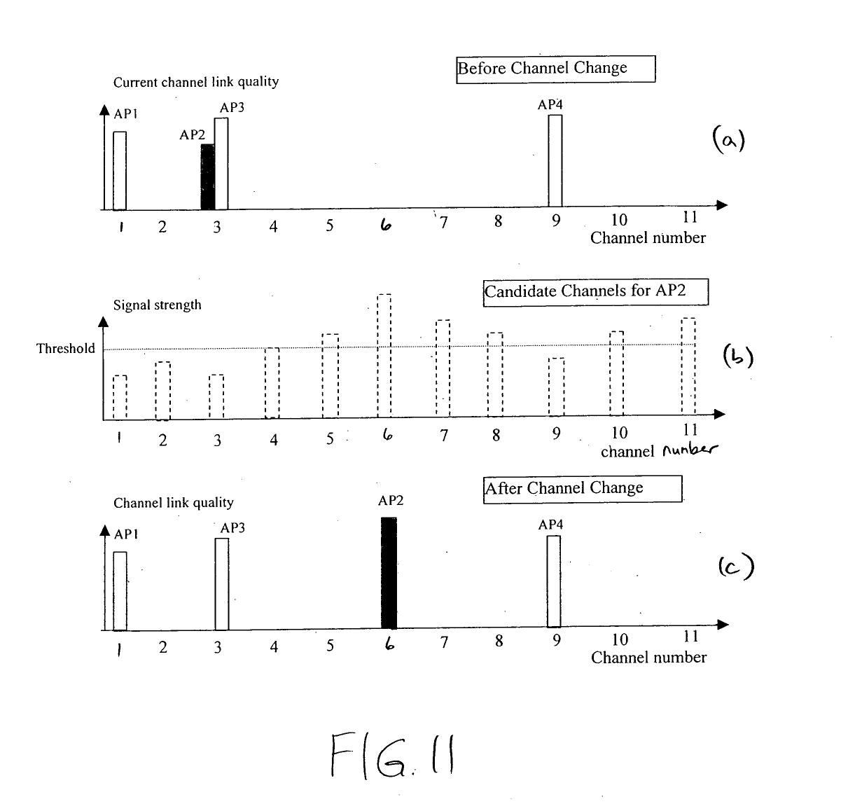

FIG. 11 illustrates a first example scenario, in accordance with an embodiment of the present invention. As shown in FIG. 11(a), in a local area, AP1 occupies channel 1; AP2 and AP3 occupy channel 3; and AP4 occupies channel 9. AP3 is the first AP to occupy channel 3, as maintained for example by a heartbeat message. AP2 and AP3 monitor current channel link quality, e.g., by using retry count or other metrics. In one embodiment, both AP2 and AP3 may determine that current channel link quality is insufficient, and both AP2 and AP3 may note that AP3 has priority to remain on channel 3. In another embodiment, AP3 may not be capable of changing channels. In either case, AP2 begins reviewing channel link qualities against a threshold to determine which channels are candidate channels. As shown in FIG. 11(b), channels 4, 5, 6, 7, 8, 10 and 11 exceed the threshold and are candidate channels. AP2 groups the candidate channels into a first priority group containing nonoverlapping channels 6 and 11, and into a second priority group containing overlapping channels 4, 5, 7, 8 and 10. Since candidate channels exist in the first priority group, one is selected at random. As shown in FIG. 11(c), AP2 selects at random channel 6 from the first priority group. AP2 switches to new channel 6.

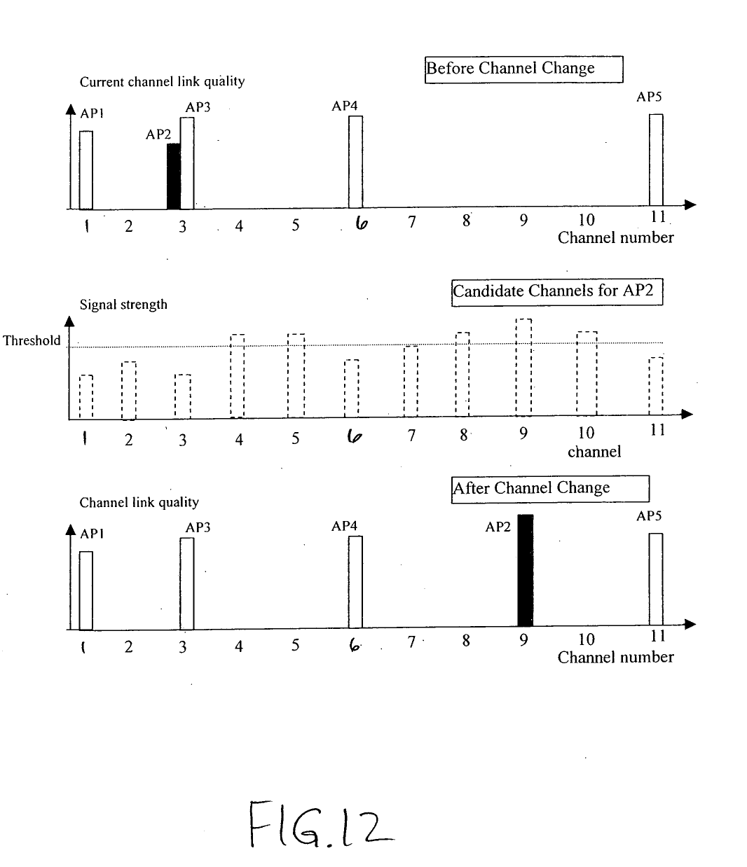

FIG. 12 illustrates a second example scenario, in accordance with an embodiment of the present invention. As shown in FIG. 12(a), in a local area, AP1 occupies channel 1; AP2 and AP3 occupy channel 3; AP4 occupies channel 6; and AP5 occupies channel 11. AP3 is the first AP to occupy channel 3. AP2 and AP3 monitor current channel link quality, e.g., by using retry count or other metrics. In one embodiment, both AP2 and AP3 may determine that link quality is insufficient, and both AP2 and AP3 may note that AP3 has priority to remain on channel 3. In another embodiment, AP3 may not be capable of changing channels. In either case, AP2 begins reviewing channel link qualities against a threshold to determine which channels are candidate channels. As shown in FIG. 12(b), channels 4, 5, 8, 9 and 10 exceed the threshold and are candidate channels. AP2 groups the candidate channels into a first priority group containing nonoverlapping channels (empty), and into a second priority group containing overlapping channels 4, 5, 8, 9 and 10. Since no candidate channels exist in the first priority group, one must be selected from the second priority group. In one embodiment, the candidate channels in the second priority group are ranked in order based on signal strength, e.g., channel 9, then channel 10, then channel 5, then channel 4 and then channel 8. AP2 picks the top three candidate channels, namely, channels 9, 10 and 5, and selects at random one of these candidate channels, e.g., channel 9. In another embodiment, AP2 selects the candidate channel with the highest signal strength, in this case, channel 9. As shown in FIG. 12(c), AP2 switches to new channel 9.

Since 802.11n operates in the same frequency bandwidth as 802.11 b/g in the 2.4 GHz, the techniques herein can be implemented in 802.11 b/g and 802.11n (with some modification). The technique of dynamic channel selection may be used in wireless home networks to improve network performance and may facilitate real-time video applications over wireless. It may also benefit channel selection in multi-channel wireless systems, too.

It will be appreciated that certain embodiments may assure that new channel selection does not repeat ad infinitum. For example, if all BSS 105 were to use the same protocol, e.g. the channel with the best SNR, all BSS 105 recognizing interference may effectively follow the same channel selection route. Random selection from predetermined sets of candidate channels may avoid this.

The foregoing description of the preferred embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
receiving a link quality value of a current channel from each of a plurality of wireless stations in a wireless network;
using the received link quality values to determine whether link quality of the current channel fails a link quality threshold; and
if the link quality fails the link quality threshold, then
receiving a signal value of each of at least two other channels from each of the plurality of wireless stations;
using the received signal values to determine whether each of the at least two other channels is a candidate channel;
using a channel-selection protocol that includes random selection to select one of the candidate channels as a new channel; and
setting the new channel as the current channel.

2. The method of claim 1, further comprising
determining by one of the wireless stations in the wireless network that the link quality of the current channel from the perspective of the one of the wireless stations is below the link quality threshold;
sending a message by the one of the wireless stations to an access point; and
initiating by the access point the step of receiving in response to the message.

3. The method of claim 1, further comprising
determining that a period of time has expired; and
initiating the step of receiving in response to the step of determining.

4. The method of claim 1, wherein the step of using the received signal values to determine whether each of the at least two other channels is a candidate channel includes
determining whether each of the received signal values fails a signal value threshold; and
excluding an other channel that fails the signal value threshold.

5. The method of claim 4, wherein the step of determining whether each of the received signal values fails the signal value threshold includes using a weighted average protocol that weights the signal values.

6. The method of claim 4, wherein the channel-selection protocol includes
determining whether each candidate channel is an overlapping channel or a nonoverlapping channel;
grouping the candidate channels are nonoverlapping in a first priority group; and
grouping the candidate channels that are overlapping channels in a second priority group.

7. The method of claim 6, wherein the channel-selection protocol includes selecting at random one of the candidate channels from the first priority group as the new channel, if the first priority group includes at least two candidate channels.

8. The method of claim 6, wherein the channel-selection protocol includes
determining that the first priority group includes no candidate channels;
ranking the candidate channels of the second priority group in order of signal quality;
selecting a predetermined number of candidate channels from the candidate channels of the second priority group based on the ranking; and
selecting at random at least one of the candidate channels of the predetermined number of candidate channels as the new channel.

9. The method of claim 1, wherein the method is performed by an access point in a basic service set of the wireless network or by a controller station in an ad-hoc network of wireless stations.

10. A system comprising:
a current channel assessment module for receiving a link quality value of a current channel from each of a plurality of wireless stations in a wireless network, and for using the received link quality values to determine whether link quality of the current channel fails a link quality threshold;
a candidate channel assessment module for receiving a signal value of each of at least two other channels from each of the plurality of wireless stations, and for using the received signal values to determine whether each of the at least two other channels is a candidate channel;
a new channel selection module for using a channel-selection protocol that includes random selection to select one of the candidate channels as a new channel; and
a new channel setting module for setting the new channel as the current channel.

11. The system of claim 10,
further comprising means for determining by one of the wireless stations in the wireless network that the link quality of the current channel from the perspective of the one of the wireless stations is below the link quality threshold, and for sending a message to an access point; and
wherein the current channel assessment module initiates receiving link quality values in response to the message.

12. The system of claim 10, wherein the current channel assessment module is operative to determine that a period of time has expired and to initiate the receiving of link quality values in response to the expiration of the period of time.

13. The system of claim 10, wherein the candidate channel assessment module is operative to determine whether each of the received signal values fails a signal value threshold, and to exclude an other channel that fails the signal value threshold.

14. The system of claim 13, wherein the candidate channel assessment module uses a weighted average protocol that weights the signal values.

15. The system of claim 13, wherein the channel-selection protocol includes
determining whether each candidate channel is an overlapping channel or a nonoverlapping channel;
grouping the candidate channels that are nonoverlapping in a first priority group; and
grouping the candidate channels that are overlapping channels in a second priority group.

16. The system of claim 15, wherein the channel-selection protocol includes selecting at random one of the candidate channels from the first priority group as the new channel, if the first priority group includes at least two candidate channels.

17. The system of claim 15, wherein the channel-selection protocol includes
determining that the first priority group includes no candidate channels;
ranking the candidate channels of the second priority group in order of signal quality;
selecting a predetermined number of candidate channels from the candidate channels of the second priority group based on the ranking; and
selecting at random at least one of the candidate channels of the predetermined number of candidate channels as the new channel.

18. The system of claim 10, wherein the system operates as an access point in a basic service set of a wireless network or operates as a controller station in an ad-hoc network of wireless stations.

19. A wireless station in a wireless network, comprising:
means for determining a link quality value of a current channel;
means for determining a signal value of each of at least two other channels; and
means for determining a new channel designation, the new channel designation being generated by a channel-selection protocol that includes random selection, and for setting the new channel as the current channel.

20. The wireless station of claim 19, wherein
the wireless network includes an ad-hoc network; and
the wireless station operates as a controller and includes
a current channel assessment module for receiving a link quality value of a current channel from each of a plurality of wireless stations in the wireless network, and for using the received link quality values to determine whether link quality of the current channel fails a link quality threshold;
a candidate channel assessment module for receiving a signal value of each of at least two other channels from each of the plurality of wireless stations, and for using the received signal values to determine whether each of the at least two other channels is a candidate channel; and
a new channel selection module for using a channel-selection protocol that includes random selection to select one of the candidate channels as a new channel.
